(19) United States
(12) Patent Application Publication
(10) Pub. No.: US 2003/0217203 A1
(43) Pub. Date: Nov. 20, 2003

(54) DMA circuit with bit handling function

(76) Inventor: Takashi Miyake, Tokyo (JP)

Correspondence Address: BURNS, DOANE, SWECKER & MATHIS, L.L.P., P.O. Box 1404, Alexandria, VA, 22313-1404, US

(21) Appl. No.: 10/291,653

(22) Filed: Nov. 12, 2002

(30) Foreign Application Priority Data
May 15, 2002 (JP) 2002-140577

(51) Int. Cl. G06F 13/28

(52) U.S. Cl. 710/22

(57) ABSTRACT

A DMA circuit include a read address register for storing a read address; a write address register for storing a write address; an OR register for storing data; a logic operation selection register for storing information indicating whether to write the read data without change or to carry out the OR operation; and a data calculation circuit for carrying out control either of writing the read data from the read address to the write address without change, or of writing the resultant data of the OR operation between the read data and the data stored in the OR register to the write address, in response to the information stored in the logic operation selection register. The DMA circuit can improve the controllability of the entire system.

### BACKGROUND OF THE INVENTION

1. Field of the Invention

The present invention relates to a DMA (Direct Memory Access) circuit consisting of a semiconductor integrated circuit.

2. Description of Related Art

FIG. 22 is a block diagram showing a configuration of a conventional DMA circuit. In this figure, the reference numeral 101 designates a DMA acknowledge control circuit, 102 designates a timing signal generating circuit, 103 designates an active channel decision circuit, 104 designates a data buffer, Ch0-Ch2 each designate a channel of the DMA circuit, 105, 107 and 109 each designate a read address register, and 106, 108 and 110 each designate a write address register.

FIG. 23 is a timing chart illustrating the operation of the conventional DMA circuit.

Next, the operation of the conventional DMA circuit will be described.

The timing chart of FIG. 23 illustrates the operation when the three-channels of the DMA simultaneously receive a DMA request based on the same request. As basic signals, the master control clock is designated by MCCLK, and the initializing (reset) signal of the circuit is denoted by INI.

In response to the occurrence of a request signal DMA_EVENT by a request, DMA request flags CH0FLG, CH1FLG, CH2FLG of the individual channels are set. According to the flag state and priorities of the individual channels, the active channel decision circuit 103 makes a decision to sequentially select the active channel in accordance with the priority, and carries out the DMA operation in the order decided. As for the conventional technique, the priority is assigned as Ch0>Ch1>Ch2, so that the selection signal is enabled in the order of SELCH0→SELCH1→SELCH2. At the same time, the active channel decision circuit 103 generates a DMA request signal DMAREQ for requesting the CPU to grant the bus right, and a signal DMAREQ1 for starting to generate the timing signals for the DMA access.

Receiving the DMA request, the CPU generates a DMA acknowledge signal DMAACK. In response to the DMA acknowledge signal DMAACK, the DMA acknowledge control circuit 101 generates an acknowledge signal DMAACK2 in the DMA circuit. In accordance with the DMAACK2 and DMAREQ1 signals, the timing signal generating circuit 102 generates various signals for the DMA access, SELRDADS, SELRDDAT, SELWRADS, SELWRDAT and SELADSEN sequentially.

In response to these signals, the DMA circuit places the data in the read address register 105 on the address bus as the address, and transfers the data at the address to the data buffer 104. Subsequently, it puts the data in the write address register 106 on the address bus, places the data in the data buffer 104 on the data bus, and writes the data to the address.

These operations are performed for the read address register and write address register of the active channel. In the conventional technique, the operations are carried out for the read address register 105 and write address register 106 of the channel Ch0, first. Subsequently, they are performed for the read address register 107 and write address register 108 of the channel Ch1, and then for the read address register 109 and write address register 110 of the channel Cj2. In this case, to prevent the DMA from occupying the bus right, the DMA circuit relinquishes the bus right each time it completes the operation for one of the channels, and carries out the DMA operation again after obtaining the new DMA request DMAREQ and acknowledge DMAACK.

With the foregoing configuration, the conventional DMA circuit can write only the entire data read from the read address to the write address without any change. Accordingly, even when the read data includes unnecessary bit information to be written, it cannot handle the unnecessary information appropriately. As a result, it has a problem of deteriorating the controllability of the entire system in such a case.

In addition, to write only fixed data in a specified write address in response to an occurrence of a request, it is necessary for the conventional DMA circuit to preset the fixed data in predetermined read addresses, and to read the data before writing it to the write addresses. The unnecessary data read also presents a problem of deteriorating the controllability of the entire system.

### SUMMARY OF THE INVENTION

The present invention is implemented to solve the foregoing problems. It is therefore an object of the present invention to provide a DMA circuit capable of improving the controllability of the entire system.

According to a first aspect of the present invention, there is provided a DMA circuit comprising: a first register for storing a read address; a second register for storing a write address; a third register for storing data; and a control circuit for carrying out logic operation between the read data from the read address and the data stored in the third register, and for controlling such that the resultant data of the logic operation is written to the write address. It can carry out the bit handling of the data during the transfer of the data. Accordingly, it can use the DMA for transferring only valid bits with good response, offering an advantage of being able to improve the controllability of the entire system.

According to a second aspect of the present invention, there is provided a DMA circuit comprising: a first register for storing a write address; a second register for storing write data; and a control circuit for carrying out control of writing the write data to the write address. It can use the DMA in the write only access mode. Accordingly, it can carry out the data transfer efficiently in a shorter time by an amount corresponding to skipping the read access, thereby offering an advantage of being able to improve the controllability of the entire system.

### BRIEF DESCRIPTION OF THE DRAWINGS

FIG. 1 is a block diagram showing a configuration of a DMA circuit of an embodiment 1 in accordance with the present invention;

FIG. 2 is a circuit diagram showing a configuration of a DMA acknowledge control circuit;

FIG. 3 is a circuit diagram showing a configuration of a timing signal generating circuit;

FIG. 4 is a circuit diagram showing a configuration of an A-type latch used by the timing signal generating circuit;

FIG. 5 is a circuit diagram showing a configuration of an active channel decision circuit;

FIG. 6 is a circuit diagram showing a configuration of a B-type latch used by the active channel decision circuit;

FIG. 7 is a circuit diagram showing a configuration of a calculation selection control circuit;

FIG. 8 is a circuit diagram showing a configuration of a data calculation circuit;

FIG. 9 is a block diagram showing a configuration of a DMA circuit of an embodiment 2 in accordance with the present invention;

FIG. 10 is a circuit diagram showing a configuration of a calculation selection control circuit;

FIG. 11 is a circuit diagram showing a configuration of a data calculation circuit;

FIG. 12 is a block diagram showing a configuration of a DMA circuit of an embodiment 3 in accordance with the present invention;

FIG. 13 is a circuit diagram showing a configuration of a calculation selection control circuit;

FIG. 14 is a circuit diagram showing a configuration of a data calculation circuit;

FIG. 15 is a block diagram showing a configuration of a DMA circuit of an embodiment 4 in accordance with the present invention;

FIG. 16 is a circuit diagram showing a configuration of a DMA acknowledge control circuit;

FIG. 17 is a circuit diagram showing a configuration of a timing signal generating circuit;

FIG. 18 is a circuit diagram showing a configuration of an active channel decision circuit;

FIG. 19 is a circuit diagram showing a configuration of a register output control circuit;

FIG. 20 is a circuit diagram showing a configuration of a data selection circuit;

FIG. 21 is a timing chart illustrating the operation of the DMA circuit of the embodiment 4 in accordance with the present invention;

FIG. 22 is a block diagram showing a configuration of a conventional DMA circuit; and

FIG. 23 is a timing chart illustrating the operation of the conventional DMA circuit.

### DETAILED DESCRIPTION OF THE PREFERRED EMBODIMENTS

The invention will now be described with reference to the accompanying drawings.

Embodiment 1

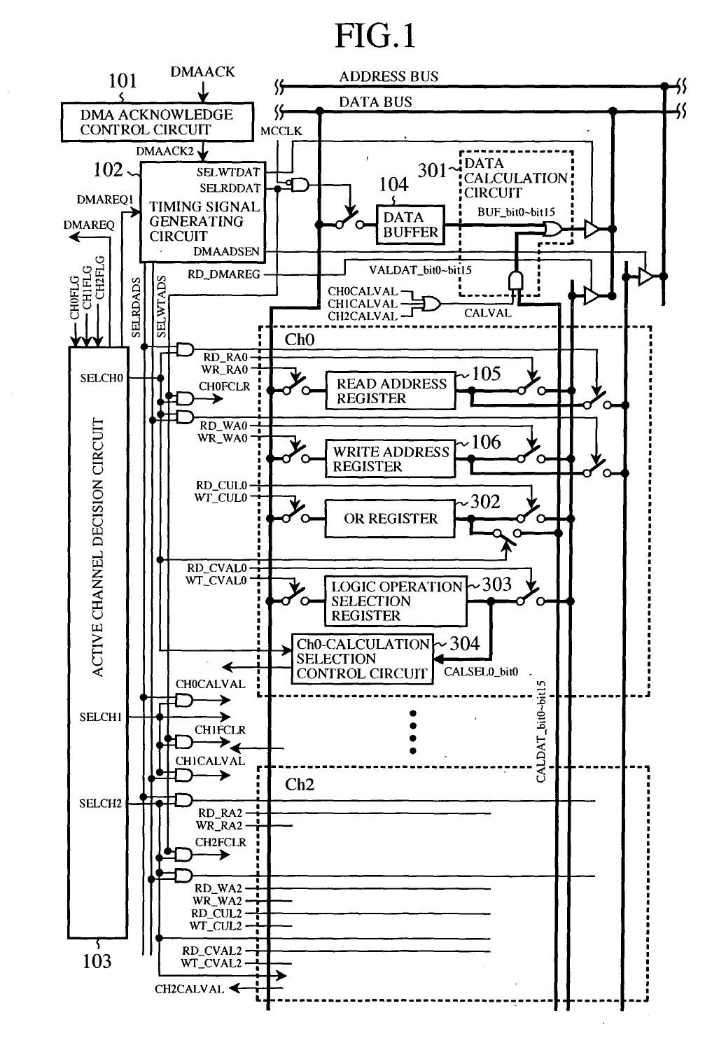

FIG. 1 is a block diagram showing a configuration of a DMA circuit of an embodiment 1 in accordance with the present invention. In this figure, the reference numeral 101 designates a DMA acknowledge control circuit; 102 designates a timing signal generating circuit; 103 designates an active channel decision circuit; 104 designates a data buffer; Ch0-Ch2 each designate a channel of the DMA circuit; 105 designates a read address register; 106 designates a write address register; 301 designates a data calculation circuit; 302 designates an OR register; 303 designates a logic operation selection register; and 304 designates a Ch0-calculation selection control circuit.

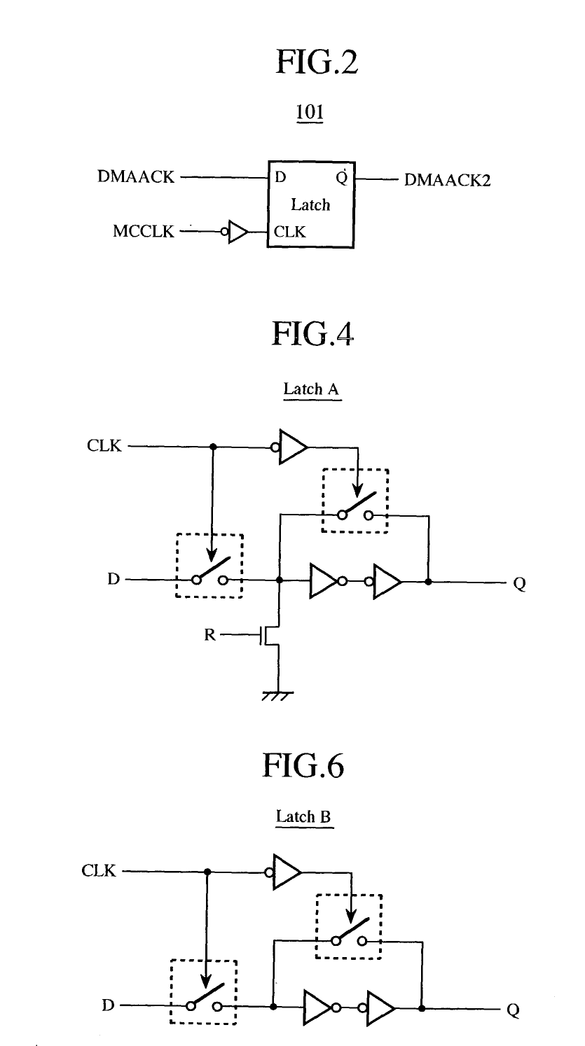

FIG. 2 is a circuit diagram showing a configuration of the DMA acknowledge control circuit 101 comprising a latch and an inverter.

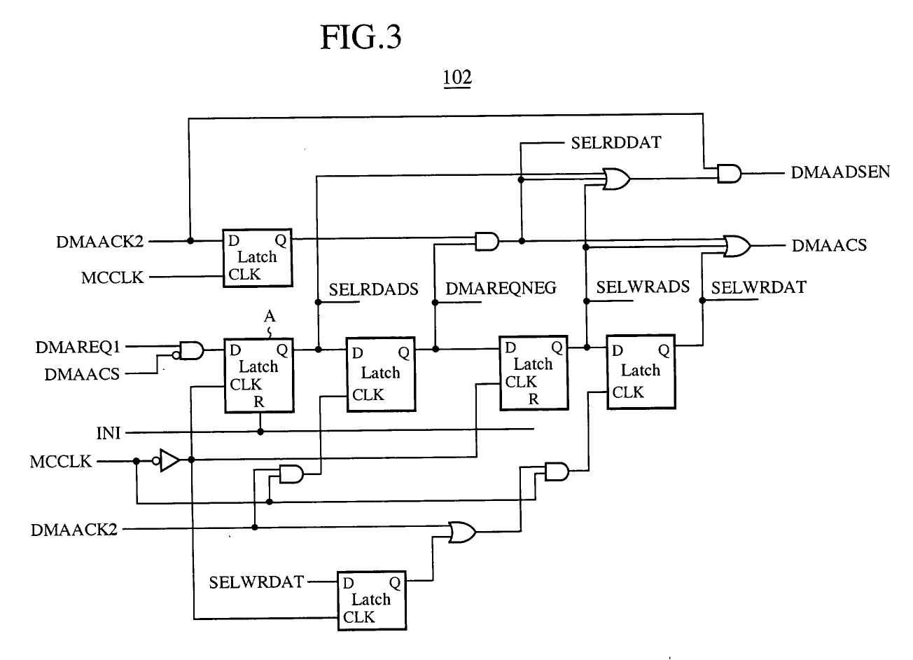

FIG. 3 is a circuit diagram showing a configuration of the timing signal generating circuit 102 comprising latches, an inverter, a NAND gate, AND gates and OR gates.

FIG. 4 is a circuit diagram showing a configuration of an A-type latch used by the timing signal generating circuit, which A-type latch comprises inverters, switches, and an N-channel transistor.

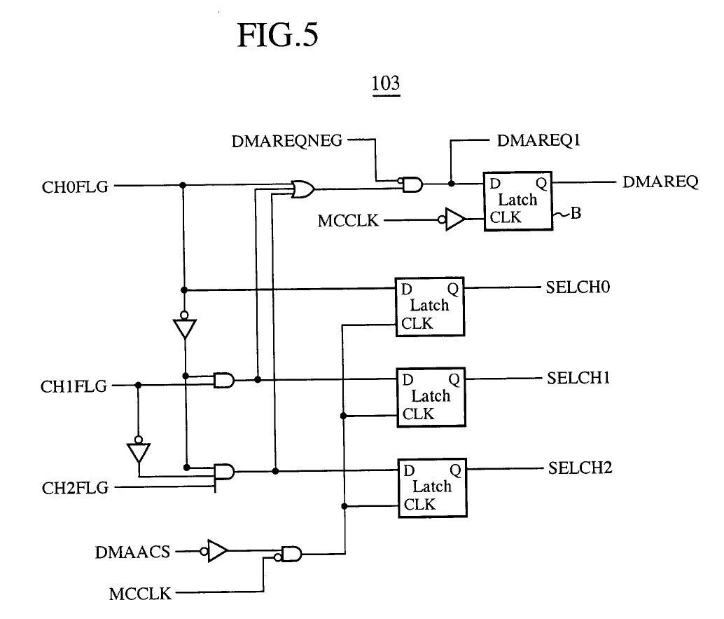

FIG. 5 is a circuit diagram showing a configuration of the active channel decision circuit 103 comprising latches, inverters, NAND gates, AND gates and an OR gate.

FIG. 6 is a circuit diagram showing a configuration of a B-type latch used by the active channel decision circuit, which B-type latch comprises inverters and switches.

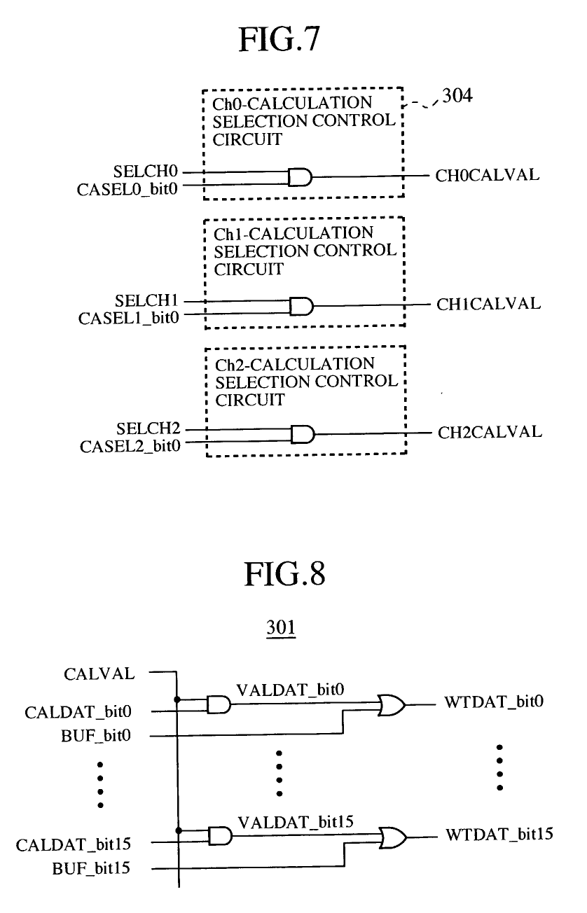

FIG. 7 is a circuit diagram showing a configuration of the calculation selection control circuits 304 each comprising an AND gate.

FIG. 8 is a circuit diagram showing a configuration of the data calculation circuit 301 comprising AND gates and OR gates.

Next, the operation of the present embodiment 1 will be described.

The present embodiment 1 selectively enables one of two access modes. In the first access mode (normal access mode), the DMA circuit writes the data read from the address specified by the read address register 105 to the address specified by the write address register 106 without change in each channel. In the second access mode (OR access mode), the data calculation circuit 301 ORs the data read from the address specified by the read address register 105 and the OR data set in the OR register 302 of each channel, and writes the resultant data into the address specified by the write address register 106.

The circuit configuration of the present embodiment 1 is basically the same as that of the conventional technique except for the following. It comprises in each channel the OR register 302 for storing the data to be ORed with the read data, and the logic operation selection register 303 for selecting one of the normal access mode and OR access mode in each channel.

In addition, it comprises next to the data buffer 104 the data calculation circuit 301 for selecting the write data in accordance with the access mode selected by the execution channel, and comprises in each channel the calculation selection control circuit 304 for generating one of the signals CH0CALVAL-CH2CALVAL indicating that the OR access of the channel becomes valid.

The DMA access operation itself is the same at that of the conventional DMA operation.

More specifically, in response to the occurrence of a request signal DMA_EVENT by a request, the DMA request flags CH0FLG, CH1FLG, CH2FLG of the individual channels are set in FIG. 1. According to the flag state and priorities of individual channels, the active channel decision circuit 103 makes a decision to sequentially select the active channel in accordance with the priority, and carries out the DMA operation in the order decided (see, FIGS. 5 and 6). As for the present embodiment 1, the priority is assigned as Ch0>Ch1>Ch2, so that the selection signal is enabled in the order of SELCH→SELCH1→SELCH2. At the same time, the active channel decision circuit 103 generates a DMA request signal DMAREQ for requesting the CPU to grant the bus right, and a signal DMAREQ1 for starting to generate timing signals for the DMA access.

Receiving the DMA request, the CPU generates a DMA acknowledge signal DMAACK. In response to the DMA acknowledge signal DMAACK, the DMA acknowledge control circuit 101 generates an acknowledge signal DMAACK2 in the DMA circuit. In accordance with the signals DMAACK2 and DMAREQ1, the timing signal generating circuit 102 generates various signals for the DMA access, SELRDADS, SELRDDAT, SELWRADS, SELWRDAT and SELADSEN sequentially (see, FIGS. 3 and 4).

In response to these signals, the DMA circuit places the data read from the read address register 105 on the address bus as the address, and transfers the data in the address to the data buffer 104.

When the execution channel selects the OR access mode, the data calculation circuit 301 ORs the read data and the data in the OR register, and places the ORed data on the data bus as the write data. Then the write address register 106 places its data on the address bus so that the ORed data is written to that address.

Each new control circuit, that is, each of the Ch0-Ch2 calculation selection control circuits 304, carries out the following control. That is, when the active flag SELCH0-SELCH2 of the channel is asserted, and hence the channel can select the OR access mode, the calculation selection control circuit 304 places the OR access validating signal CH0CALVAL-CH2CALVAL of the channel at “H” (high) level (see, FIG. 7). When one of the OR access validating signals CH0CALVAL-CH2CALVAL is enabled (“H” level), the data calculation circuit 301 ORs the data in the data buffer 104 and the data in the OR register of the active channel. In contrast, when none of the CH0CALVAL-CH2CALVAL signals is valid (“L” level), the data calculation circuit 301 is controlled such that it outputs the data in the data buffer 104 without change.

Incidentally, the OR access mode is selected when the bit of the logic operation selection register 303 of each channel is “1” in the present embodiment 1.

As described above, the present embodiment 1 enables the bit handling during the data transfer. Accordingly, it can transfer only valid bits with a good response using the DMA, thereby being able to improve the controllability of the entire system.

In addition, since the present embodiment 1 can select one of the access modes of writing the read data to the write address without change, and of writing the ORed data to the write address, it can increase the convenience of the system.

Embodiment 2

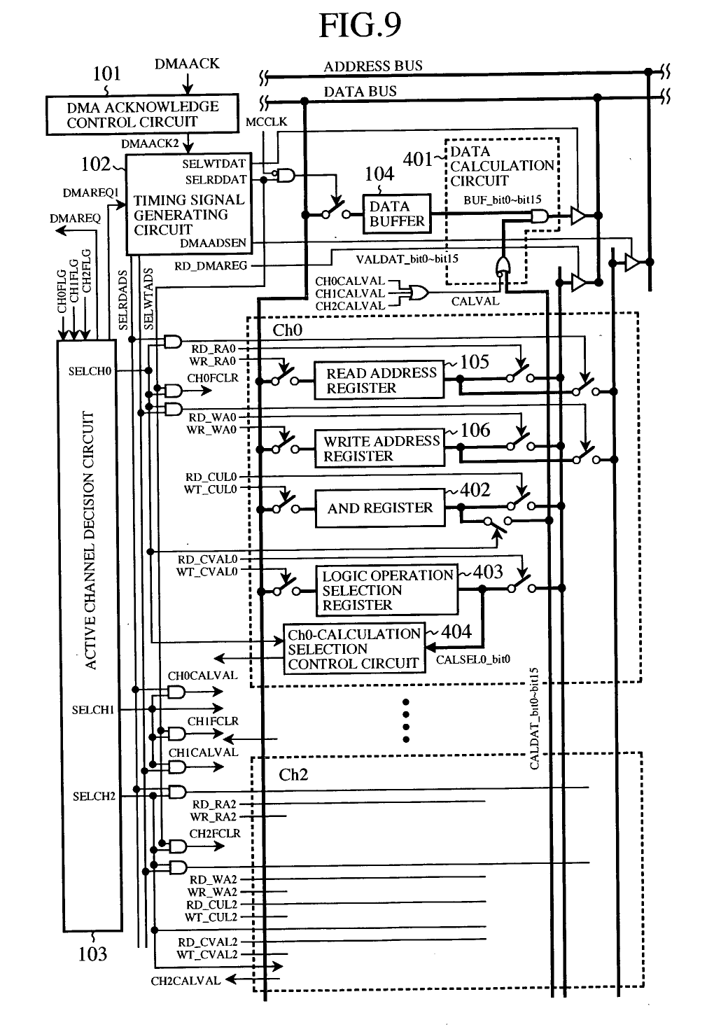

FIG. 9 is a block diagram showing a configuration of a DMA circuit of an embodiment 2 in accordance with the present invention. In this figure, the reference numeral 401 designates a data calculation circuit, 402 designates an AND register, 403 designates a logic operation selection register, and 404 designates a Ch0-calculation selection control circuit.

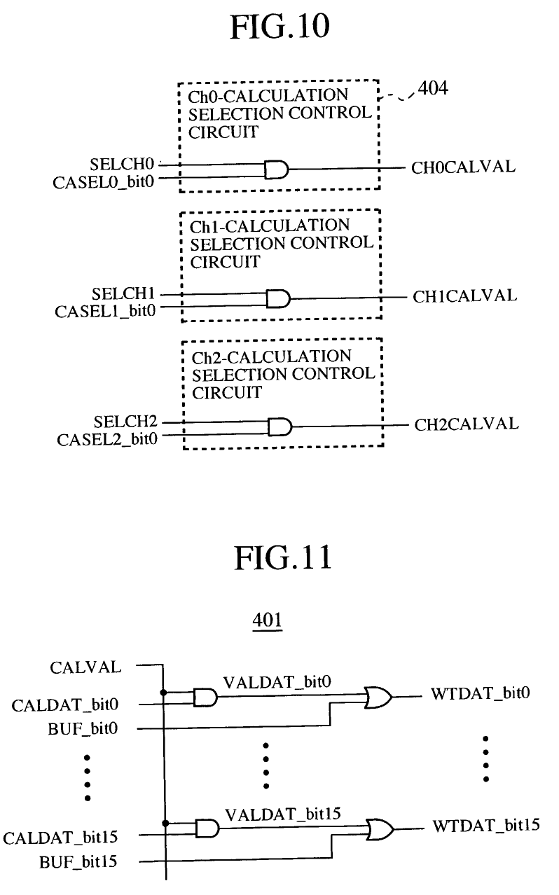

FIG. 10 is a circuit diagram showing a configuration of the calculation selection control circuits 404 each consisting of an AND gate.

FIG. 11 is a circuit diagram showing a configuration of the data calculation circuit 401 comprising AND gates and NOR gates.

The remaining configuration is the same as that of the foregoing embodiment 1.

Next, the operation of the present embodiment 2 will be described.

The present embodiment 2 selectively enables one of two access modes. In the first access mode (normal access mode), the DMA circuit writes the data read from an address specified by the read address register 105 into the address specified by the write address register 106 without change in each channel. In the second access mode (AND access mode), the data calculation circuit 401 ANDs the data read from the address specified by the read address register 105 and the AND data set in the AND register 402 of each channel, and writes the resultant data into the address specified by the write address register 106.

The circuit configuration of the present embodiment 2 is basically the same as that of the conventional technique except for the following. It comprises in each channel the AND register 402 for setting the data to be ANDed with the read data, and the logic operation selection register 403 for selecting one of the normal access mode and AND access mode in each channel.

In addition, it comprises next to the data buffer 104 the data calculation circuit 401 for selecting the write data in accordance with the access mode selected by the execution channel, and comprises in each channel the calculation selection control circuit 404 for generating one of the signals CH0CALVAL-CH2CALVAL indicating that the AND access of the channel becomes valid.

Although the basic DMA access operation itself is the same at that of the conventional DMA operation, the present embodiment 2 differs in the following. When the execution channel selects the AND access mode, the data calculation circuit 301 ANDs the read data and the data in the AND register 402, and places the ANDed data on the data bus as the write data. Then the write address register 106 places its data on the address bus so that the ANDed data is written to that address.

Each new control circuit, that is, each of the Ch0-Ch2 calculation selection control circuits 404, carries out the following control. That is, when the active flag SELCH0-SELCH2 of the channel is asserted, and hence the channel can select the AND access mode, the calculation selection control circuit 404 places the AND access validating signal CH0CALVAL-CH2CALVAL of the channel at “H” (high) level (see, FIG. 10). When one of the AND access validating signals CH0CALVAL-CH2CALVAL is enabled (“H” level), the data calculation circuit 401 ANDs the data in the data buffer 104 and the data in the AND register 402 of the active channel. In contrast, when none of the CH0CALVAL-CH2CALVAL signals is valid (“L” level), the data calculation circuit 401 is controlled such that it outputs the data in the data buffer 104 without change.

Incidentally, the AND access mode is selected when the bit of the logic operation selection register 403 of each channel is “1” in the present embodiment 2.

As described above, the present embodiment 2 enables the bit handling during the data transfer. Accordingly, it can transfer only valid bits with a good response using the DMA, thereby being able to improve the controllability of the entire system.

In addition, since the present embodiment 2 can select one of the access modes of writing the read data to the write address without change, and of writing the ANDed data to the write address, it can increase the convenience of the system.

Embodiment 3

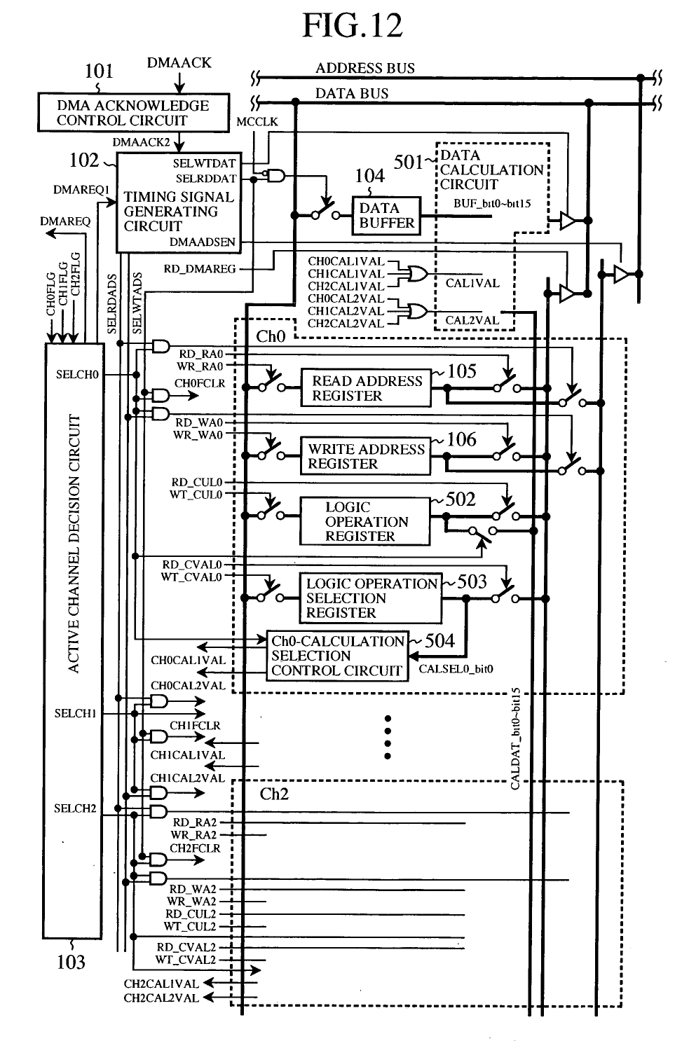

FIG. 12 is a block diagram showing a configuration of a DMA circuit of an embodiment 3 in accordance with the present invention. In this figure, the reference numeral 501 designates a data calculation circuit, 502 designates a logic operation register, 503 designates a logic operation selection register and 504 designates a Ch0-calculation selection control circuit.

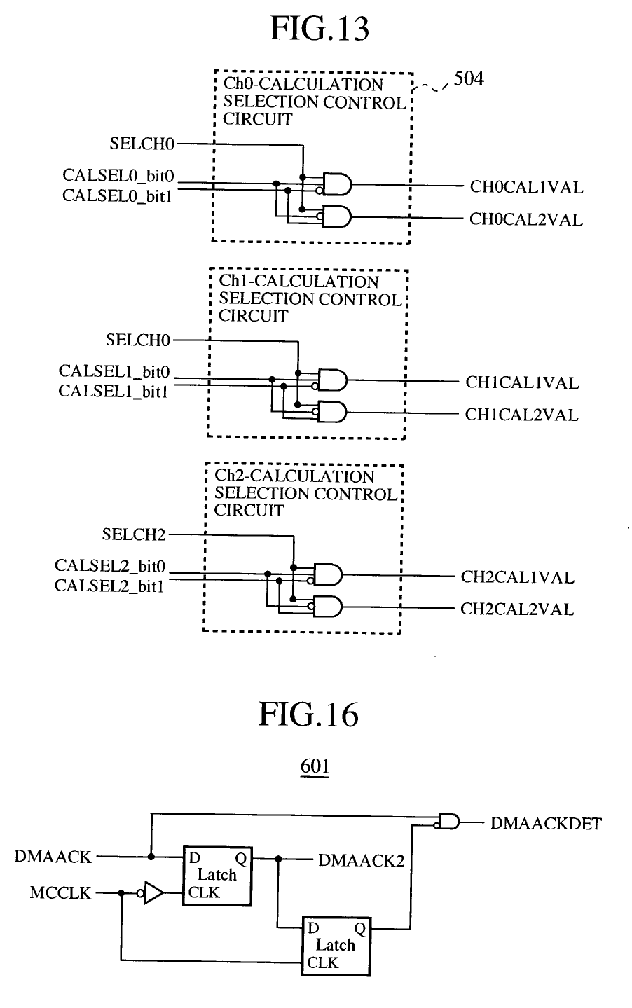

FIG. 13 is a circuit diagram showing a configuration of the calculation selection control circuits 504, each of which comprises NAND gates.

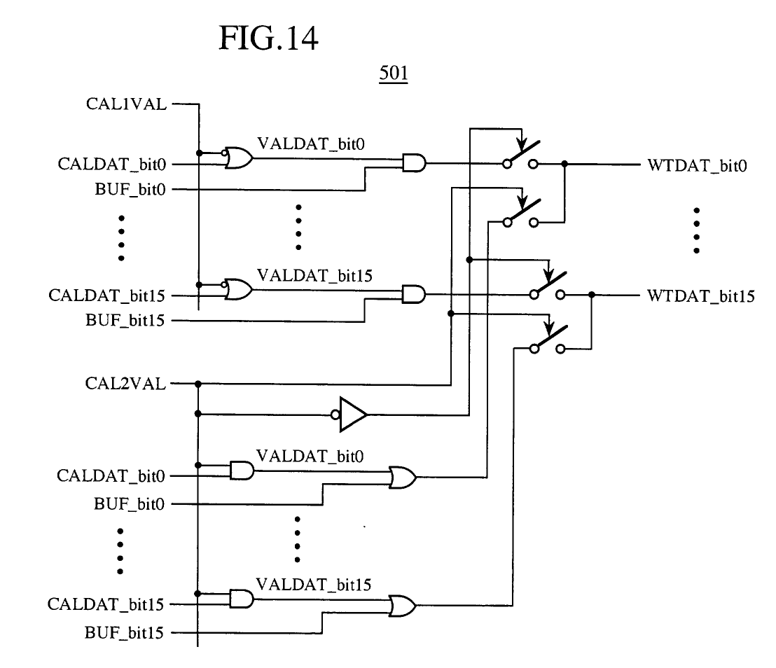

FIG. 14 is a circuit diagram showing a configuration of the data calculation circuit 501 comprising AND gates, OR gates, NOR gates, an inverter and switches.

The remaining configuration is the same as that of the foregoing embodiment 1.

Next, the operation of the present embodiment 3 will be described.

The present embodiment 3 selectively enables one of two access modes. In the first access mode (normal access mode), the DMA circuit writes the data read from an address specified by the read address register 105 into the address specified by the write address register 106 without change in each channel. In the second access mode (logic operation access mode), the data calculation circuit 501 carries out the logic operation between the data read from the address specified by the read address register 105 and the data set in the logic operation register 502 of each channel, and writes the resultant data into the address specified by the write address register 106. In addition, it can select one of the logic operations AND and OR in the logic operation access mode.

Although the circuit configuration of the present embodiment 3 is basically the same as that of the conventional technique, it differs in comprising in each channel the logic operation register 502 for setting the data to be subjected to the logic operation with the read data, and the logic operation selection register 503 for selecting one of the normal access mode, OR access mode and AND access mode in each channel.

In addition, it comprises next to the data buffer 104 the data calculation circuit 501 for selecting the write data in accordance with the access mode selected by the execution channel. It further comprises in each channel the calculation selection control circuit 504 for generating one of the signals CH0CAL1VAL-CH2CAL1VAL indicating that the OR access of the channel becomes valid, and one of the signals CH0CAL2VAL-CH2CAL2VAL indicating that the AND access of the channel becomes valid.

Although the basic DMA access operation itself is the same at that of the conventional DMA operation, the present embodiment 3 differs in the following. When the execution channel selects the OR access mode, the data calculation circuit 501 ORs the read data and the data in the logic operation register 502, and places the ORed data on the data bus as the write data. Likewise, when the execution channel selects the AND access mode, the data calculation circuit 501 ANDs the read data and the data in the logic operation register 502, and places the ANDed data on the data bus as the write data. Then the write address register 106 places its data on the address bus so that the data passing through the logic operation is written to that address.

Each new control circuit, that is, each of the Ch0-Ch2 calculation selection control circuits 504, carries out the following control. That is, when the active flag SELCH0-SELCH2 of the channel is asserted, and the channel selects the OR access mode, the calculation selection control circuit 504 places the OR access validating signal CH0CAL1VAL-CH2CAL1VAL of the channel at “H” (high) level. Likewise, when the active flag SELCH0-SELCH2 of the channel is asserted, and the channel selects the AND access mode, the calculation selection control circuit 504 places the AND access validating signal CH0CAL2VAL-CH2CAL2VAL of the channel at “H” (high) level (see, FIG. 13). When one of the AND access validating signals CH0CAL1VAL-CH2CAL1VAL is enabled (“H” level), the data calculation circuit 501 ORs the data in the data buffer 104 and the data in the logic operation register 502 of the active channel. Likewise, when one of the AND access validating signals CH0CAL2VAL-CH2CAL2VAL is enabled (“H” level), the data calculation circuit 501 ANDs the data in the data buffer 104 and the data in the logic operation register 502 of the active channel. In contrast, when none of the CH0CAL1VAL-CH2CAL1VAL and CH0CAL2VAL-CH2CAL2VAL signals is valid (“L” level), the data calculation circuit 501 is controlled such that it outputs the data in the data buffer 104 without change.

Incidentally, the present embodiment 3 selects the OR access mode when the logic operation selection register 503 of each channel takes the bit values (bit 1, bit 0)=(0, 1), and the AND access mode when (bit 1, bit 0)=(1, 0). Otherwise, it selects the normal access mode.

As described above, the present embodiment 3 enables the bit handling during the data transfer. Accordingly, it can transfer only valid bits with a good response using the DMA, thereby being able to improve the controllability of the entire system.

In addition, since the present embodiment 3 can select the access mode of writing the read data to the write address without change, or the access mode of writing the ORed data or ANDed data to the write address, it can increase the convenience of the system.

Embodiment 4

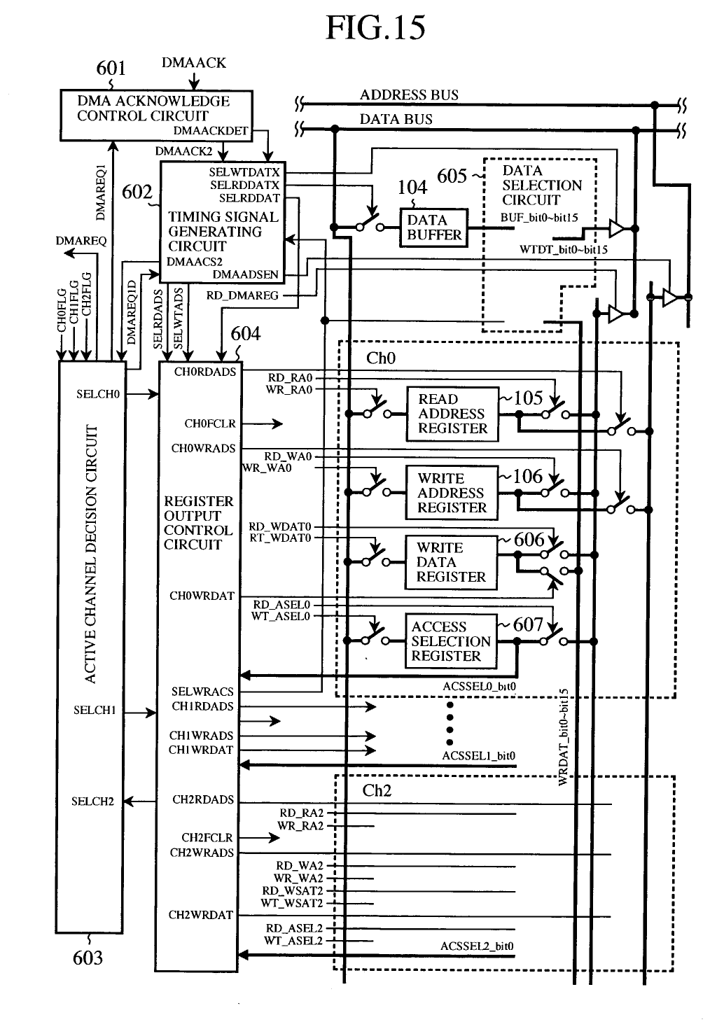

FIG. 15 is a block diagram showing a configuration of a DMA circuit of an embodiment 4 in accordance with the present invention. In this figure, the reference numeral 601 designates a DMA acknowledge control circuit, 602 designates a timing signal generating circuit, 603 designates an active channel decision circuit, 604 designates a register output control circuit, 104 designates a data buffer, Ch0-Ch2 each designate a channel of the DMA circuit, 105 designates a read address register, 106 designates a write address register, 605 designates a data selection circuit, 606 designates a write data register, and 607 designates an access selection register.

FIG. 16 is a circuit diagram showing a configuration of the DMA acknowledge control circuit 601 comprising two latches, a NAND gate, and an inverter.

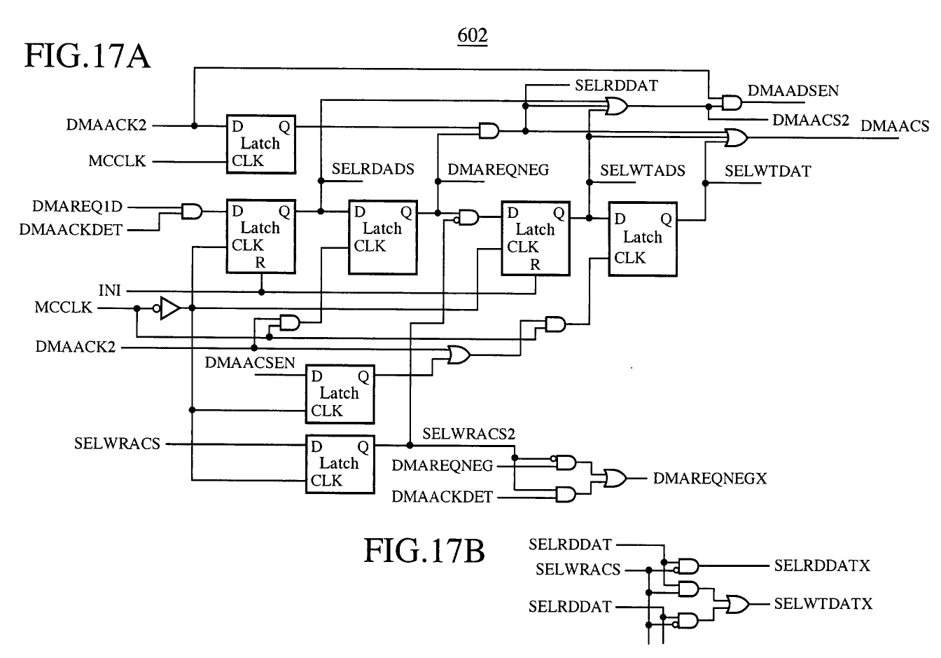

FIG. 17 is a circuit diagram showing a configuration of the timing signal generating circuit 602 comprising latches, an inverter, NAND gates, AND gates and OR gates.

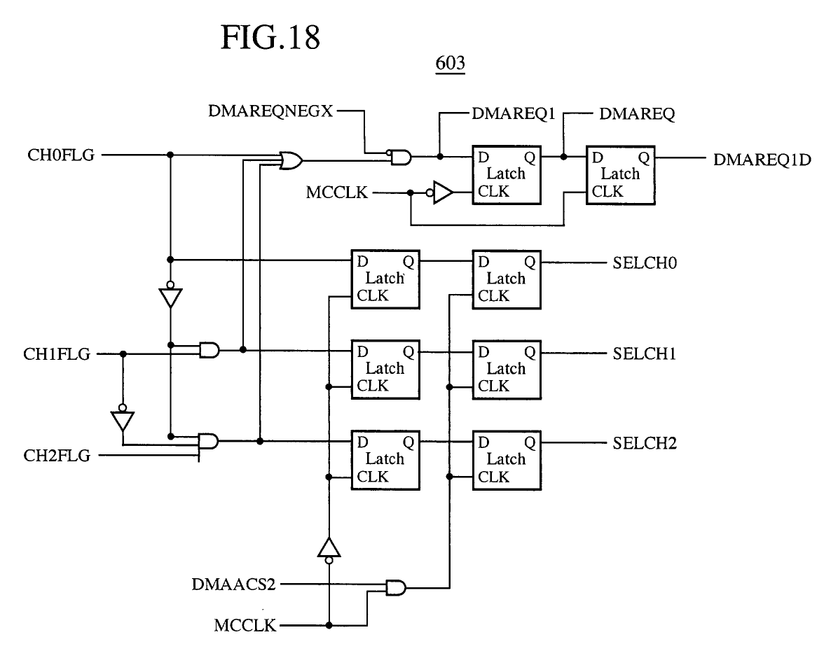

FIG. 18 is a block circuit diagram showing a configuration of the active channel decision circuit 603 comprising latches, inverters, a NAND gate, AND gates and an OR gate.

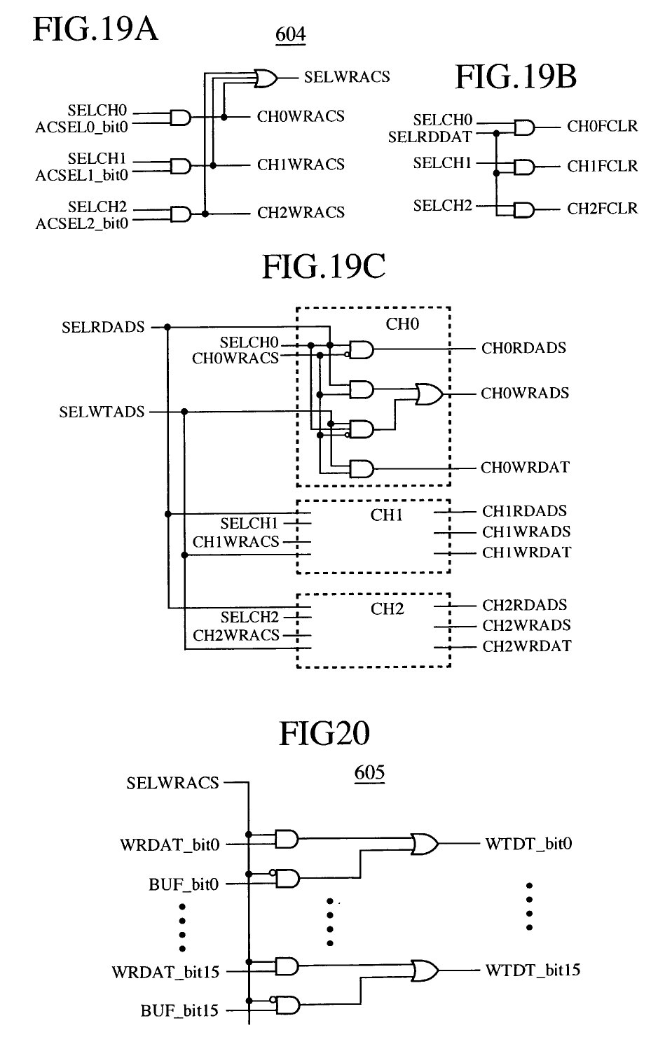

FIG. 19 is a circuit diagram showing a configuration of the register output control circuit 604 comprising NAND gates, AND gates and OR gates.

FIG. 20 is a circuit diagram showing a configuration of the data selection circuit 605 comprising AND gates, NAND gates and OR gates.

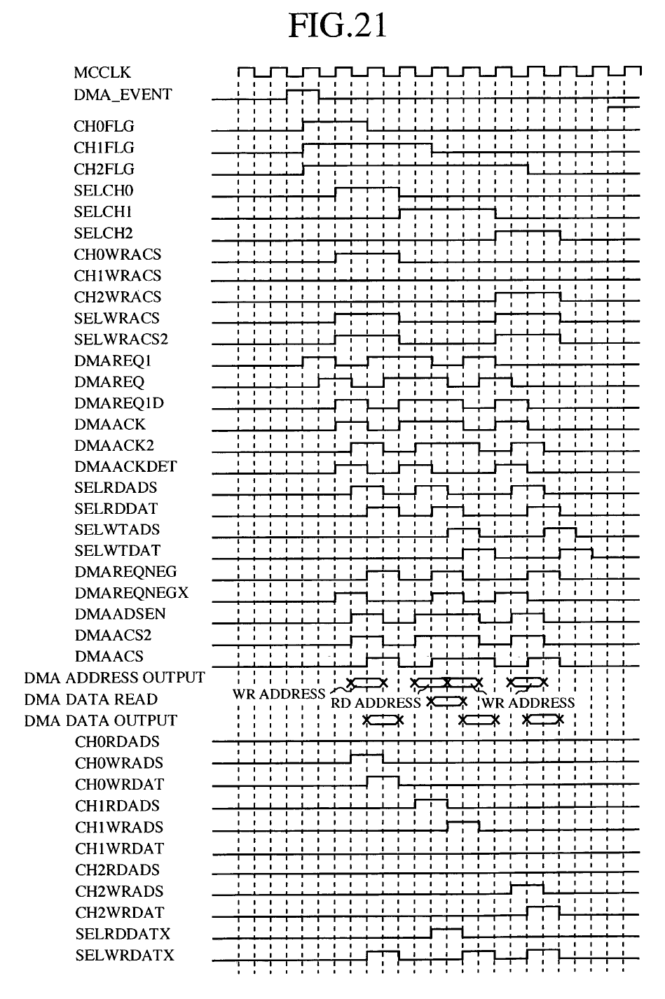

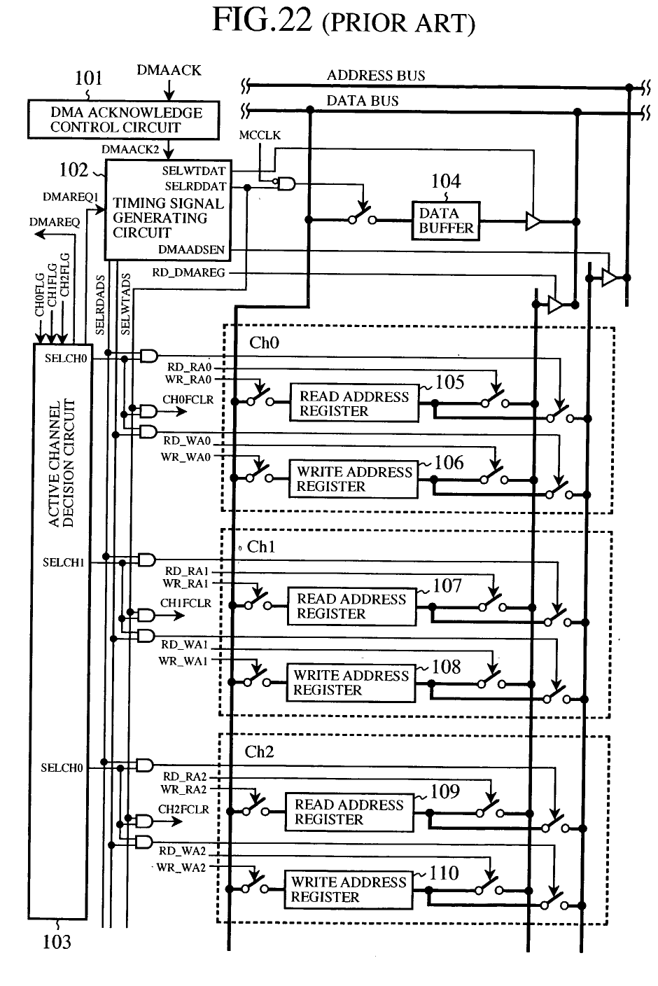

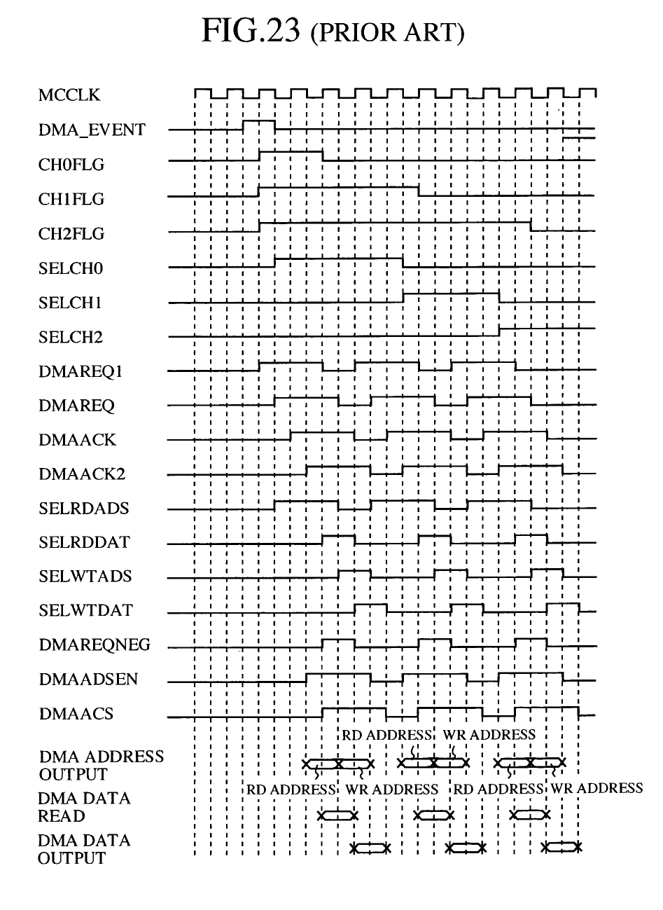

FIG. 21 is a timing chart illustrating the operation of the DMA circuit of the embodiment 4 in accordance with the present invention.

Next, the operation of the present embodiment 4 will be described.

The present embodiment 4 selectively enables one of two access modes. In the first access mode (normal access mode), the DMA circuit writes the data read from an address specified by the read address register 105 into the address specified by the write address register 106 without change in each channel. In the second access mode (write only access mode), the DMA circuit skips the read access, and writes the data stored in the write data register 606 into the address specified by the write address register 106 in each channel.

Although the circuit configuration of the present embodiment 4 is basically the same as that of the conventional technique, it differs in comprising in each channel the write data register 606 for storing the write data in the write only access mode, and the access selection register 607 for selecting one of the normal access mode and the write only access mode.

The DMA circuit further comprises next to the data buffer 104 the data selection circuit 605 for selecting the write data in accordance with the access mode of the execution channel, and the register output control circuit 604 for generating control signals of the registers in the individual channels in accordance with the access mode.

Referring to the timing chart of FIG. 21, the operation of the present embodiment 4 will be described. FIG. 21 illustrates the operation of the case where Ch0 selects the write only access mode, Ch1 selects the normal access, and Ch2 selects the write only access mode, and the processing is carried out in the order of priority of Ch0→Ch1→Ch2.

When a DMA request DMA_EVENT occurs, the request flags CH0FLG-CH2FLG of the individual channels are set simultaneously, and the active channel decision circuit 603 enables the execution of the Ch0 (places the SELCH0 at “H”) in response to the DMA request to the CPU and the channel priority (see, FIG. 18).

According to the SELCH0-SELCH2 signals and the bit-0 information of the access selection registers 607 of the individual channels, the register output control circuit 604 generates write only access acknowledge signals CH0WRACS-CH2WRACS of the individual channels, and a write only access acknowledge signal SELWRACS signal of any one of the channels (see, FIG. 19(a)). In this case, since the Ch0 selects the write only access mode, the signals CH0WRACS and SELWRACS are enabled.

Accordingly, the timing signal generating circuit 602 generates only the SELRDADS and SELRDDAT signals without generating the SELWTADS or SELWTDAT which will usually follow in the normal access mode. When the signals CH0WRACS and SELWRACS are active, the read access control based on the signals SELRDADS and SELRDDAT which is carried out in the normal access mode, generates the signal CH0WRACS in synchronism with the signal SELRDADS and the signals CH0WRDAT and SELWRDATX in synchronism with the signal SELRDDAT, without generating the signals CH0RDADS and SELRDDATX (see, FIG. 17). Thus, the DMA circuit places the address in the write address register 106 of the Ch0 on the address bus, and the data in the write data register 606 on the data bus to carry out the write access.

In addition, when the write only access mode acknowledge signal SELWRACS is active, the control of the DMA request signal to the CPU negates the DMA request not by the usual signal DMAREQNEG, but by the DMAREQNEGX that negates using the DMAACKDET (see, FIG. 17(a)), thereby relinquishing the bus right once to the CPU after executing the write access.

After the release of the negation, the requests of the remaining channels Ch1 and Ch2 take place, and the access of the higher priority channel Ch1 is carried out (generates the signal SELCH1). Since the CH1 selects the normal access, it does not generate the signals CH0WRACS-CH2WPACS and SELWRACS. Accordingly, the normal access is carried out as follows. The CPU generates the acknowledge signal DMAACK. In response to the signal, the timing signal generating circuit 602 generates the control signals SELRDADS, SELRDDAT, SELWTADS and SELWTDAT, and the normal control signals CH1RDADS, SELRDDATX, CH1WTADS and SELWTDATX to carry out the normal access (see, FIG. 17). The control of the DMA request signal to the CPU carries out its control by generating the DMAREQNEGX signal from the DMAREQNEG (see, FIG. 17(a)).

After completing the access of the Ch1, the DMA circuit enables the request of the remaining channel Ch2 (generates the SELCH2) to start the Ch2 access. Since the Ch2 selects the write only access mode, the DMA circuit carries out the same control of the channel Ch0, thereby completing the write only access mode.

As described above, the present embodiment 4 can use the DMA using only the write access. Thus, it can carry out the DMA more efficiently in a shorter time by an amount corresponding to the read access omitted in the present embodiment, thereby being able to improve the controllability of the entire system.

In addition, it can increase the convenience of the system because it can select one of the normal access mode that writes the read data to the write address, and the write only access mode that writes the write data to the write address.

What is claimed is:

1. A DMA circuit comprising:
a first register for storing a read address in a DMA access mode;
a second register for storing a write address in the DMA access mode;
a third register for storing data for a logic operation; and
a control circuit for carrying out logic operation between read data from the read address stored in said first register and the data stored in said third register, and for controlling such that resultant data of the logic operation is written to the write address stored in said second register.

2. The DMA circuit according to claim 1, further comprising a fourth register for storing information indicating whether to write the read data without change or to subject the read data to an OR operation, wherein
said control circuit has an OR operation function, and carries out, in response to the information stored in said fourth register, control of one of writing the read data to the write address without change and writing the resultant data of the OR operation between the read data and the data stored in said third register to the write address.

3. The DMA circuit according to claim 1, further comprising a fourth register for storing information indicating whether to write the read data without change or to subject the read data to an AND operation, wherein
said control circuit has an AND operation function, and carries out, in response to the information stored in said fourth register, control of one of writing the read data to the write address without change and writing the resultant data of the AND operation between the read data and the data stored in said third register to the write address.

4. The DMA circuit according to claim 1, further comprising a fourth register for storing information indicating whether to write the read data without change, or to subject the read data to an OR operation or to an AND operation, wherein
said control circuit has an OR operation function, and carries out, in response to the information stored in said fourth register, control of one of writing the read data to the write address without change, writing the resultant data of the OR operation between the read data and the data stored in said third register to the write address, and writing the resultant data of the AND operation between the read data and the data stored in said third register to the write address.

5. A DMA circuit comprising:
a first register for storing a write address in a DMA access mode;
a second register for storing write data; and
a control circuit for carrying out control of writing the write data in said second register to the write address in said first register.

6. The DMA circuit according to claim 5, further comprising a third register for storing a read address in the DMA access mode; and
a fourth register for storing information indicating whether to write read data or the write data, wherein
said control circuit carries out, in response to the information in said fourth register, control of one of writing the read data fed from the read address designated by said third register to the write address designated by said first register, and writing the write data stored in said second register to the write address designated by said first register.
